(19) United States
(12) Patent Application Publication
(10) Pub. No.: US 2025/0299575 A1
(43) Pub. Date: Sep. 25, 2025

(54) CONTROL OF THE MOVEMENT OF A SEMI-AUTONOMOUS OR AUTONOMOUS MOTORISED ROAD VEHICLE APPROACHING A LEVEL CROSSING

(71) Applicant: VALEO VISION, Bobigny (FR)

(72) Inventors: Richard Denis, Bobigny (FR); Brouk Wedajo, Bobigny (FR); Romain Demarets, Bobigny (FR); Samia Ahiad, Bobigny (FR); Virginie Taillandier, Bobigny (FR)

(73) Assignee: VALEO VISION, Bobigny (FR)

(21) Appl. No.: 18/863,776

(22) PCT Filed: May 10, 2023
(86) PCT No.: PCT/FR2023/000094

§ 371 Date: Nov. 7, 2024

(30) Foreign Application Priority Data
May 10, 2022 (FR) FR2204433

(51) Int. Cl. G08G 1/0967; G08G 1/16; H04W 4/44

(52) U.S. Cl. CPC G08G 1/096725; G08G 1/096783; G08G 1/164; G08G 1/166; H04W 4/44

(57) ABSTRACT

An embedded system for controlling movement for an autonomous or semi-autonomous motorized road vehicle and to a fixed piece of infrastructure located in a level-crossing zone crossing a road, the embedded system and infrastructure interacting by means of at least one message transmitted by the infrastructure via wireless communication and received by the embedded system. The at least one message contains one or more pieces of information relating to a signaling and/or protecting system installed in said level-crossing zone and/or relating to one or more structural components of said signaling and/or protecting system. The embedded system is configured to decide on how to handle the movement control of the vehicle based on said one or more pieces of information extracted from said at least one received message.

### TECHNICAL FIELD

The present invention relates to the general field of semi-autonomous or autonomous motorized road vehicles, and more particularly focuses on making control of movement of this type of vehicle in the vicinity of a level crossing safer.

### TECHNOLOGICAL BACKGROUND

In order to increase road safety, certain motor vehicles, referred to as semi-autonomous motor vehicles, are equipped with partial automation systems or advanced driver-assistance systems (known by the acronym ADAS), and in particular with systems that carry out, instead of the driver, the lateral control and/or the longitudinal control of the vehicle, or at the very least alert the driver of a potentially dangerous situation in order to make it possible for him/her to react in time. It is also expected that motor vehicles will eventually become completely autonomous, i.e. that they will eventually not need a driver.

Advanced driver-assistance systems thus have the general function of alerting the driver to a situation requiring his/her attention and/or of defining the path that the vehicle must follow to arrive at a given destination, thereby making it possible to control units for controlling the steering and/or braking and acceleration of the vehicle, so that this path is actually followed automatically. Path must be understood here in its mathematical sense, i.e. as being the set of successive positions that must be occupied by the vehicle over time. Thus, advanced driver-assistance systems must define not only the route to be taken, but also the speed profile to be respected. To do this, they are equipped with at least one detecting module, which detects many pieces of information on the immediate environment of the vehicle (presence of obstacles such as pedestrians, of bicycles or other motorized vehicles, traffic signs, road configuration, road line markings, etc.), which pieces of information are delivered by one or more environment-perceiving sensors with which the vehicle is equipped, i.e. sensors such as cameras, radars and/or lidars, as well as pieces of information related to the vehicle itself, such as its speed, its acceleration, and its position, which is for example given by a GPS navigation system.

In the case of a semi-autonomous vehicle, ADAS systems allow, under certain driving conditions, temporary delegation of the task of driving, and may be activated or deactivated at the driver's discretion. In the case of an autonomous vehicle, the concept of driver is no longer relevant, and the embedded systems of the vehicle must allow the environment to be perceived, hazards to be analyzed, the paths to follow to reach a destination to be selected, and all the necessary longitudinal and lateral controls to be executed.

It should be readily understood that in such semi-autonomous or autonomous vehicles the embedded movement-controlling systems must guarantee a high level of safety in a maximum number of driving situations. In other words, since the decisions taken by semi-autonomous or autonomous vehicles are based on an analysis of the environment such as perceived by the various perception sensors, it will be understood that it is not only necessary to develop detecting modules capable of detecting, on the basis of pieces of information delivered by the perception sensors, specific characteristics of the environment suited to specific driving situations, but also essential to provide solutions allowing the overall amount of confidence that can be had in the ability of these perception modules to detect the specific characteristics for which they were designed.

Among specific driving situations, level crossings (corresponding below to a place where a railway line crosses a roadway) are zones in which there is a high risk of accidents and they therefore form part of the road situations that an embedded control system should be able to handle.

Certain developments in recent years have focused solely on the set of problems related to the risk of collision with a train. Thus, document DE 10 2016 202 508 A1 discloses a system for increasing the safety of a level crossing that is particularly suitable for open level crossings, the system comprising a device for determining a status of the rail traffic on the railway line, a device for communicating with a road user (such as a pedestrian or an autonomous or non-autonomous motor vehicle), and wireless communication means for communicating the status of the rail traffic determined by the determining device to the communicating device. In one of the embodiments described in this document, the road user is an autonomous motorized vehicle, and the transmitting device and the communicating device are preferably included in an infrastructure-to-vehicle communication system. The safety system allows the motor vehicle to determine whether it must give way to the train, even if a suitable sensor for detecting an approaching rail vehicle is not available on this vehicle or cannot be used.

However, the risk of collision between a semi-autonomous or autonomous motorized vehicle and a train is not the only problem associated with making control of vehicle movement in the vicinity of a level crossing safe.

Specifically, it would also be very desirable for the embedded control system to be able to perceive and understand the scene being played out at the moment when the vehicle reaches the level-crossing zone and/or at the moment when it crosses the level crossing, and for it to be able to do so regardless of how soon a train will pass.

In a more general context of recent developments, so-called cooperative intelligent transport systems (C-ITS) have introduced vehicle-to-vehicle (V2V) and vehicle-to-infrastructure (V2I or I2V) communications, which are intended to prevent accidents. To guarantee system interoperability, a set of standards has been developed. Certain standards, such as the standard ISO/TS 19091, the standard ETSI TS 103 301 and the standard SAE J2735, describe standardized MAPEM messages, and other standards, such as the standard ETSI EN 302 637-3, describe standardized DENM messages (DENM standing for Decentralized Environmental Notification Message).

In the context of application of these standards to the issue of level crossings, it is currently planned that MAPEM messages generated by infrastructure installed in a level-crossing zone will in particular describe the geometry associated with the actual intersection of the traffic lanes and railway tracks, namely:
the number of traffic lanes entering, exiting and crossing the level crossing, as well as the number of railway tracks;
the width, and direction of travel of each of the traffic lanes and railway tracks and the angle at which the rails are positioned with respect to the traffic lanes;
a sequence of three-dimensional positions in a global reference frame (for example GPS coordinates or coordinates of the system WGS 84) making it possible to identify, on the one hand, a section of railway track at the intersection, and on the other hand, at least three traffic-lane sections per direction of travel, allowing a first section upstream of the railway tracks, a second section crossing the railway tracks and a third section downstream of the railway tracks to be characterized.

Moreover, it is currently planned that a DENM message generated by infrastructure installed in a level-crossing zone will be able to apprise a vehicle:
of the presence of a level crossing via a specific variable named “eventType”, the variable being set equal to an identifier corresponding to the presence of a level crossing;
of a map of the road network including the level crossing through a succession of three-dimensional positions in a global reference frame (for example coordinates of the system WGS 84) allowing traffic-lane sections crossing the railway tracks of a level crossing and various road sections leading to the zone including the level crossing to be identified.

The information transmitted according to the aforementioned standards currently relates only to the geometry of the railway tracks and of the traffic lanes involved in a level crossing. They are currently insufficient to allow a control system embedded in a semi-autonomous or autonomous vehicle to perceive and fully understand, on the basis solely of the messages transmitted by a piece of infrastructure, the scene being played out at the moment when the vehicle reaches the level-crossing zone and/or at the moment when it decides to cross the level crossing, and therefore to be able to decide the best way, in terms of safety, to handle control of the movement of the vehicle.

### SUMMARY OF THE INVENTION

The present invention aims to overcome the drawbacks of the prior art.

To do this, one subject of the present invention is an embedded system for controlling movement for an autonomous or semi-autonomous motorized road vehicle, the system comprising, in an autonomous or semi-autonomous motorized road vehicle, at least one external sensor configured to perceive information on a nearby zone located at least in front of the motorized road vehicle, at least one detecting module configured to detect, based on the information perceived by said at least one external sensor, characteristics of the nearby zone, a receiving module configured to receive, via wireless communication, at least one message transmitted by a fixed piece of infrastructure located in a level-crossing zone crossing a road over which said vehicle is moving, and a processing module configured to automatically control the movement of the motorized road vehicle based either on characteristics detected by said at least one detecting module, or on said at least one message received by the receiving module, the system being characterized in that it is configured to extract, from said at least one received message, one or more pieces of information relating to a signaling and/or protecting system installed in said level-crossing zone and/or relating to one or more structural components of said signaling and/or protecting system, and in that the processing module is configured to decide how to handle the movement control based on said one or more extracted pieces of information.

In one possible embodiment, said one or more pieces of information extracted from said at least one received message comprises an indication defining the category of the level crossing in which the signaling and/or protecting system is installed.

In one possible embodiment, said one or more extracted pieces of information comprise a set of indications relating to the structural components of said signaling and/or protecting system, said components belonging to one or more of the following classes: traffic lights, barriers, road line markings, traffic signs, traffic bollards, level-crossing panels, audio warning devices, emergency call boxes, height restriction barriers.

In one possible embodiment, the embedded system is further configured to extract from said at least one received message one or more pieces of geometric information relating to the roadways and railways intersecting in the level-crossing zone and/or to sections of overhead lines overlying said level crossing.

In one possible embodiment, said processing module is configured to assist said at least one detecting module with detecting structural characteristics corresponding to one or more pieces of information extracted from said at least one received message.

For example, the processing module may further be configured to determine an entry boundary and/or an exit boundary and/or a presence of the level crossing and/or an open or closed status of the level crossing on the basis of at least detected structural characteristics corresponding to one or more pieces of information extracted from said at least one received message and relating to one or more structural components of said signaling and/or protecting system.

In one possible embodiment, said processing module is configured to determine, based on said one or more pieces of information extracted from said at least one received message, whether said at least one external sensor and/or said at least one detecting module and/or the processing module are capable of handling crossing the level crossing.

In one possible embodiment, said processing module is configured to determine, based on said one or more pieces of information extracted from said at least one received message, whether said motorized road vehicle is permitted, at least in terms of dimensions and/or weight, to cross the level crossing.

Another subject of the present invention is a fixed piece of infrastructure located in a level-crossing zone crossing a road, said fixed piece of infrastructure comprising a transmitting module configured to transmit messages via wireless communication, said fixed piece of infrastructure being characterized in that the transmitting module is capable of including, in at least one message to be transmitted, one or more pieces of information relating to a signaling and/or protecting system installed in said level-crossing zone, and/or relating to one or more structural components of said signaling and/or protecting system.

### BRIEF DESCRIPTION OF THE FIGURES

The description that follows with reference to the appended drawings, which are given by way of non-limiting examples, will allow of what the invention consists and how it may be carried out to be clearly understood. In the appended figures:

FIG. 1 schematically shows one example of a configuration of a level-crossing zone corresponding to an intersection between a road and a railway, equipped with a fixed piece of infrastructure according to the invention;

FIG. 2 schematically illustrates a semi-autonomous or autonomous vehicle equipped with an embedded system capable of controlling the movement of the vehicle according to the invention.

### DESCRIPTION OF ONE OR MORE EMBODIMENTS

The present invention is based on the observation that the messages transmitted by infrastructure according to the aforementioned current standards relate solely to the geometry of the railway tracks and traffic lanes defining a level crossing.

However, every level-crossing zone is generally equipped with its own signaling and/or protecting system, the configuration of which may be relatively elaborate. Indeed, at the present time, in France, level crossings are classified into a number of categories, including the following non-limiting categories:
level crossings signaled by a St Andrew's cross (category code PN XSA), which are crossed entirely at the road user's own risk and where absolute priority is given to rail traffic;
open level crossings with warning lights (category code PN SAL 0), which are equipped with two or four red lights (in France, R24 lights) that flash when it is necessary for road users to come to an absolute stop, and which may be equipped with an audio signaling device;
half-barrier level crossings with warning lights, in which there is one barrier per direction of travel (category code PN SAL 2), and which are also equipped with red lights (in France, R24 lights) that flash when it is necessary for road users to come to an absolute stop, and which may be equipped with an audio signaling device;
full-barrier level crossings with warning lights, in which there are two entry half-barriers and two exit half-barriers (category code PN SAL 4), and which are also equipped with red lights (in France, R24 lights) that flash when it is necessary for road users to come to an absolute stop, and which may be equipped with an audio signaling device.

Moreover, information may also be provided by road-traffic signs or signals (other than the R24 lights or the St Andrew's cross) in the level-crossing zone. Thus, in certain cases, entry and/or exit boundaries of level-crossing zones are marked by road line markings, whereas in other cases no line markings are used to mark these boundaries. Furthermore, certain legislation may require traffic signs and/or bollards to be used to warn that a level crossing is being approached, or even to indicate the category of the level crossing (whether it has a barrier or not).

The present invention proposes to make available all or some of the pieces of information relating to a signaling and/or protecting system installed in a level-crossing zone and/or to one or more structural components of this system.

By “structural components”, what is meant is equipment or means potentially used to signal and/or protect a level-crossing zone, and which may be grouped into the following classes:
traffic lights, for example R24 lights;
barriers (called XK3 barriers in French legislation);
road line markings that may define an entry boundary, and/or an exit boundary, of the level-crossing zone, and/or lateral boundaries (or side lines) of the road on the level crossing;
road signs, irrespectively of whether it is a question of signs specific to the level crossing (for example a St Andrew's cross, or any sign that is of type G under French legislation) or of road signs placed on the edge of the road upstream of the level crossing, for example signs depicting a barrier or a locomotive (signs of type A7 and A8 under French legislation) or even of information regarding the heights of vehicles permitted to cross a level crossing (sign of type B12 under French legislation);
traffic bollards, the number of strips of which depends on the distance from the bollard to the level crossing (bollards of type J10 under French legislation);
panels of the level crossing;
audio warning devices;
emergency call boxes;
height restriction barriers (called type G3 in French legislation).

A piece of information relating to a signaling and/or protecting system may for example be an indication defining the category of the level crossing in which the system is installed.

According to the present invention, all or some of the aforementioned pieces of information are transmitted, via wireless communication, by a fixed piece of infrastructure located in a level-crossing zone crossing a road, preferably within one or more messages broadcast constantly or periodically, or even occasionally.

Furthermore, according to the invention, these pieces of information transmitted in the message(s) can be received by a system for controlling movement with which an autonomous or semi-autonomous road vehicle is equipped, this system possessing a receiving module configured to receive the message(s) via wireless communication, when it reaches the vicinity of the level-crossing zone, and being configured to extract these pieces of information contained in the received message(s) and to subsequently decide the way in which it will handle the movement control.

By “handle the movement control” what in particular is meant is:
longitudinal and/or lateral control that allows the vehicle to stop automatically before crossing the level crossing, or to automatically cross the level crossing or even to determine a new route avoiding crossing the level crossing;
a decision to give back control to a driver in the case of a semi-autonomous vehicle.

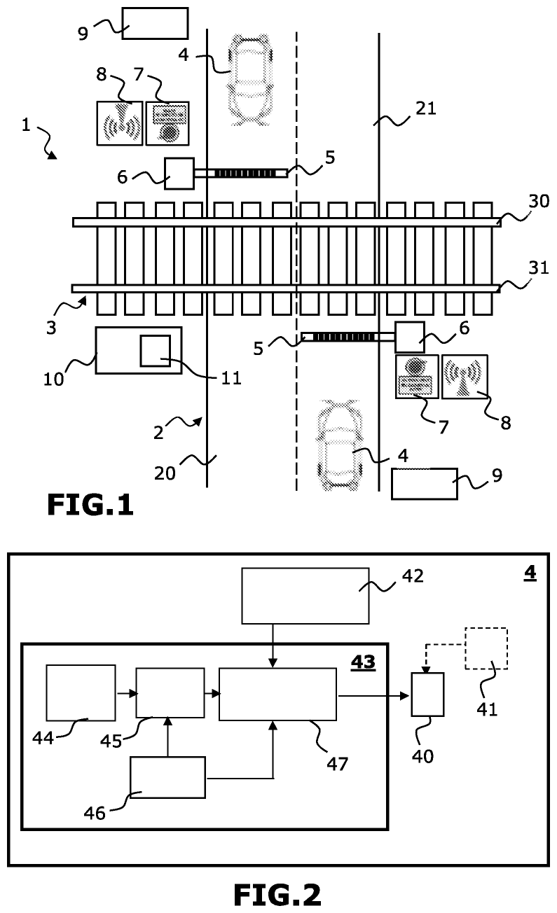

In order to better illustrate the principles of the invention, FIG. 1 schematically shows one non-limiting example of configuration of a level-crossing zone 1 corresponding to an intersection between a two-way road 2 (i.e. a road with two directions of travel) and a railway track 3.

The road 2 here has two traffic lanes 20 and 21 in which motorized vehicles may pass one another by, just like the two vehicles 4 illustrated, in the example, stopped in their respective lanes upstream of the level crossing. The railway track 3 is here composed of two rails 30 and 31 to allow movement of a train (not shown). A signaling and/or protecting system is conventionally installed in the level-crossing zone. In the non-limiting example, the level crossing is of category PN SAL 2 and hence the following components form part of the signaling and/or protecting system:
two entry half-barriers 5 pivotally mounted on their respective bases 6;
at least two red lights 7 (R24 lights) per direction of travel;
two audio signaling devices 8.

The signaling and/or protecting system further comprises a certain number of other components (all referenced 9 in FIG. 1), for example corresponding to the aforementioned traffic signs and/or traffic bollards and/or emergency call boxes and/or height restriction barriers.

A fixed piece of infrastructure 10 in particular allowing 12V wireless communications is located in the level-crossing zone 1. This piece of infrastructure 10 comprises a transmitting module 11 configured to transmit messages via a wireless communication link. The communications are for example according to any of the following technologies: 4G, 5G, LTE-V2X, NR-V2X, Wi-Fi 802.11p, and Wi-Fi 802.11bd, this list not being exhaustive. According to the invention, the transmitting module 11 is capable of including, in at least one message to be transmitted, one or more of the aforementioned pieces of information relating to the configuration of the signaling and/or protecting system.

In the non-limiting case shown in FIG. 1, the message will thus potentially contain an indication that the level crossing of the zone 1 is here a level crossing of category PN SAL 2, and a set of indications relating to the half-barriers 5 and/or to the traffic lights 7 and/or to the audio signaling devices 8, and/or to any of the components referenced 9.

For a level crossing the signaling and/or protecting system of which differs from the one schematically shown in FIG. 1, a piece of infrastructure similar to the piece of infrastructure 10 may be installed; however, the content of the message or messages transmitted will advantageously be tailored to the configuration of the associated signaling and/or protecting system.

It will be noted that, for most of the aforementioned classes of components, the set of indications may in particular advantageously comprise a number of components per class and/or the geographical coordinates of each component, and/or a size or shape, and/or a type, and/or an index of visibility of the component from the road (visibility in particular potentially being affected by the presence of trees or other obstacles). For example, in the case of FIG. 1, said at least one broadcast message will potentially include the fact that there are two half-barriers 5, the length of each half-barrier 5, and the geographical coordinates (GPS or WGS 84 coordinates) of their connection with their respective support 6.

For certain classes, other indications may be added. By way of non-limiting examples:
For the class of barriers and/or for the class of traffic lights and/or for the class of emergency call boxes and/or for the class of audio warning devices, provision may be made to include, in the message(s), status information making it possible to indicate whether the component in question (barrier, light, emergency call box, and/or audio warning device) is faulty or operational.
For the class of barriers, it may be advantageous to also include, in the message(s), an indication as to the angular speed of opening and/or closing of the barrier, and/or to the angle of inclination of the barrier with respect to the horizon when the barrier is in the fully open or fully closed position, and/or to the angle of the barrier with respect to the road layout as drawn on a horizontal plane, and/or to the height of the barrier with respect to the ground, and/or to a time taken to lower and/or open the barriers. Other indications relating to the physical appearance of the barrier may also be advantageously added to the message(s), especially since physical appearance may differ depending on the legislation of the country (for example red-and-white checkerboard color or yellow-and-red checkerboard color, etc.).
For the class of audio warning devices, an indication may be included as to the audio frequency and/or loudness, and/or to variations in the audio frequency/loudness over time, and/or to the active or inactive status of the warning device (the active or inactive status depending for example on the environmental context (day/night or presence of dwellings)).
For the class of traffic lights, provision may be made to include an indication as to the frequency at which they flash and/or an indication as to whether they flash synchronously or in alternation with other traffic lights of the system and/or to the physical appearance, which may differ depending on the legislation of the country.
For the class of panels, provision may be made to include indications relating to physical appearance (color and/or level of contrast with the road and rails), and/or indications as to the material used (rubber, concrete, etc.).

Other pieces of information to be included in the message(s) and still regarding the configuration of the level crossing may be envisioned, such as a closing and opening sequence (duration of activation of the R24 lights before the barriers lower, how long the barriers stay lowered, minimum delay before passage of a train) and/or the telephone number associated with the emergency call boxes or the level crossing itself. If there are no road line markings, the message may also advantageously include an indication as to the one or more structural components of the system that may be used by the system embedded in the vehicle as reference points to derive a theoretical entry or exit boundary.

In possible embodiments, ancillary pieces of information, i.e. pieces of information not related to the signaling and/or protecting system as such, may be added to the message(s). In particular, said transmitting module 11 may further be capable of also including, in the message(s) to be transmitted, one or more pieces of geometric information relating to the traffic lanes and railway tracks intersecting in the level-crossing zone and/or to sections of overhead lines overlying said level crossing, in a similar way to what is planned at the present time for MAPEM messages. Thus, in the non-limiting example of FIG. 1, said at least one message to be transmitted by the fixed piece of infrastructure 10 will potentially also specify information relating to the geometry of the two traffic lanes 20 and 21, and of the rails 30 and 31 of the single railway track 3.

FIG. 2 schematically illustrates a semi-autonomous or autonomous vehicle 4 equipped with an embedded system capable of controlling the movement of the vehicle according to the invention. The vehicle 4 is equipped, in a conventional manner, with control units 40 (typically a steering wheel and accelerator and brake pedals in the case of a semi-autonomous vehicle, in order to allow the vehicle to be maneuvered by a driver 41, or analogous means in the case of a completely autonomous vehicle without a driver). The vehicle 4 is further equipped, in a conventional manner, with a plurality of internal sensors (all referenced 42), such as a speed sensor, a steering-angle sensor and a GPS navigation system, allowing the vehicle to obtain information on its current state (current speed, current acceleration, current heading being followed with respect to a reference frame associated with the vehicle, current position with respect to an embedded HD map containing context-related information, such as regulations in respect of speed limit, the road type, etc.). The vehicle 4 is lastly equipped with an embedded system 43 for automatically controlling the movement of the vehicle, which is designed to act on the control units 40 instead of the driver 41.

The embedded system 43 comprises one or more external sensors 44 (for example an image sensor and/or a radar and/or a lidar and/or a sound sensor) allowing it to perceive information on a nearby zone located at least in front of the vehicle 4, at least one detecting module 45 configured to detect, based on the information perceived by the external sensor(s) 44, characteristics of the nearby zone, and a receiving module 46 configured to receive, via a wireless link, messages from outside the vehicle 4, and in particular messages from the fixed piece of infrastructure 10 of FIG. 1. A processing module 47 receives the outputs of the detecting module 45, of the internal sensors 42 and of the receiving module 46 so as to be able to automatically control the movement of the vehicle 4 based either on characteristics detected by the detecting module(s) 45, or on the message received by the receiving module 46, while taking into account the odometry of the vehicle 4.

According to the invention, the embedded system 43 is configured to extract from said at least one message received from the fixed piece of infrastructure 10, one or more pieces of information contained in this message, so that the processing module 47 may decide on a handling strategy to adopt in the movement control of the vehicle 4.

The adoptable strategies may be very diverse and depend of course on the information contained in the message(s) transmitted by the fixed piece of infrastructure associated with a level-crossing zone.

For example, in one possible embodiment, the processing module 47 is advantageously configured to determine, based on the one or more pieces of information extracted from said at least one received message, whether the external sensor(s) 44 and/or the associated detecting module(s) 45 and/or the processing module 47 have/has the ability to handle crossing of the level crossing. Here, the expression “ability” must be understood to mean that the embedded system 43 for controlling movement has indeed been designed to be able to handle one or more categories of level crossing and/or to perceive and detect one or more components of the signaling and/or protecting system associated with the level crossing, and/or that the components of this signaling system are indeed operational.

Ability/inability may for example be determined based on the category of the level crossing, and/or on the status (operational/faulty) and/or even on the visibility index of at least one component of the signaling and/or protecting system, if these pieces of information are indeed contained in the received message. Thus, by way of non-limiting example, the processing module 47 may decide that the system 43 is not able to safely handle crossing of a level crossing if it is informed, by the message(s) received, that it is a level crossing of category PN SAL 0 while the system 43 has been designed to handle only level crossings of category PN SAL 2, or even if it is informed that a component is associated with a poor visibility index, or even if no indication relating to road line markings defining entry, exit and/or lateral boundaries is contained in the received message(s). Ability/inability may also be determined based on the type of panels of the level crossing, and/or on the distance between an entry barrier and an exit barrier. Other rules allowing the processing module 47 to determine the ability or inability to handle crossing may of course be followed without departing from the scope of the invention.

In another possible embodiment, which may optionally be combined with the preceding embodiment, the processing module 47 is advantageously configured to determine, still based on one or more pieces of information extracted from said at least one received message, whether the vehicle 4 it equips is permitted to cross the level crossing (even in cases where no train is about to pass or passing). The concept of permission is distinct from the concept of ability seen above, and is here related to regulatory proscriptions of the highway code, in particular in terms of the dimensions and/or weight of the vehicle 4, or even of what may be transported by this vehicle 4.

Permission may be in particular be granted/denied based on pieces of information relating to certain traffic signs upstream of the level crossing and/or an indication as to the presence of a height restriction barrier associated with the height of the crossbar of that barrier, this list not being exhaustive.

If the processing module 47 determines that the system 43 is unable to handle crossing of the level crossing and/or that the vehicle 4 is not permitted to cross the level crossing, it may decide, for example:
in the case of an autonomous vehicle 4, to generate longitudinal and/or lateral control commands allowing the vehicle to stop automatically before crossing the level crossing, or even to determine a new route avoiding the need to cross the level crossing;
in the case of a semi-autonomous vehicle 4, to give back control to the driver (in other words to deactivate autonomous mode).

In another possible embodiment, which may optionally be combined with either of the preceding embodiments (or even both), the processing module 47 is advantageously configured to help the one or more detecting modules 45 detect structural characteristics corresponding to one or more pieces of information extracted from the received message(s), by means of the external sensor(s) 44.

For example, if the processing module 47 is informed, by the received message(s), that it is a question of a level crossing of category PN SAL 2, the embedded system 43 knows that it must try to detect, via its sensors 44, the associated components.

One particular advantage of this embodiment is that the embedded system may in particular anticipate the presence of a level crossing with an increased level of confidence, as a result of the high number of structural characteristics that the indications contained in the message(s) allow it to detect via its own sensors. Furthermore, even if one of the messages is a DENM message and already contains, according to the standards, direct information on the presence of a level crossing (via the specific variable named “eventType”), the embedded system 43 may combine this direct information with the structural characteristics it has detected, further increasing the level of confidence in the detection of the presence of a level crossing. The embedded system 43 is then advantageously able to better prepare for the approach phase, by deciding on the best way to handle the movement control.

In another possible embodiment, the processing module 47 is further configured to determine an entry boundary and/or an exit boundary on the basis of at least detected structural characteristics corresponding to one or more pieces of information extracted from received message(s) and relating to one or more structural components of said signaling and/or protecting system. This is a real advantage because an entry boundary or an exit boundary may turn out to be complex to determine, whereas these two data are essential to allowing the vehicle 4 to either correctly handle stopping just before the entry boundary if required to, or to avoiding stopping between an entry boundary and an exit boundary when crossing the level crossing. By virtue of the invention, even when no direct information relating to road line markings defining entry or exit boundaries of the level-crossing zone is contained in the received message(s), the embedded system 43 is able to derive by itself an entry boundary and/or an exit boundary on the basis of structural characteristics detected thereby. It is for example possible to determine a virtual entry boundary on the basis of the position of the R24 lights and/or of the barriers, which the embedded system 43 will be able to detect via its own sensors 44 following the indications related to the presence of such lights or such barriers contained in a received message. Furthermore, even if a received message contains direct information relating to the position of road line markings defining entry or exit boundaries, the embedded system 43 may nevertheless combine this direct information with the structural characteristics that it has detected, further increasing the level of confidence associated with the determined entry boundary and/or exit boundary.

It will be readily understood that there are a great many other possibilities that it has not been possible to describe exhaustively, regarding the characteristics that the embedded system 43 may detect with greater reliability via its own sensors by virtue of the pieces of information contained in the received message(s), for example presence of a level crossing and/or whether the level crossing is in an open or closed state.

1. An embedded system for controlling movement for an autonomous or semi-autonomous motorized road vehicle, the system comprising:
in the autonomous or semi-autonomous motorized road vehicle,
at least one external sensor configured to perceive information on a nearby zone located at least in front of the motorized road vehicle,
at least one detecting module configured to detect, based on the information perceived by said at least one external sensor, characteristics of the nearby zone;
a receiving module configured to receive, via wireless communication, at least one message transmitted by a fixed piece of infrastructure located in a level-crossing zone crossing a road over which said vehicle is moving; and
a processing module configured to automatically control the movement of the motorized road vehicle based either on characteristics detected by said at least one detecting module, or on said at least one message received by the receiving module,
wherein the system is configured to:
extract, from said at least one received message, one or more pieces of information relating to a signaling and/or protecting system installed in said level-crossing zone and/or relating to one or more structural components of said signaling and/or protecting system,
wherein the processing module is configured to decide how to handle the movement control based on said one or more extracted pieces of information.

2. The embedded system as claimed in claim 1, wherein said one or more pieces of information extracted from said at least one received message comprises an indication defining a category of a level crossing in which the signaling and/or protecting system is installed.

3. The embedded system as claimed in claim 1,
wherein said one or more extracted pieces of information comprise a set of indications relating to the structural components of said signaling and/or protecting system,
wherein said components belonging to one or more of the following classes: traffic lights, barriers, road line markings, traffic signs, traffic bollards, level-crossing panels, audio warning devices, emergency call boxes, height restriction barriers.

4. The embedded system as claimed in claim 3, wherein said set of indications comprises, for each class, a number of components and/or, for each component, geographical coordinates, and/or a size or shape, and/or a type, and/or an index of visibility from the road.

5. The embedded system as claimed in claim 3, wherein said set of indications further comprises:
for the class of barriers and/or for the class of traffic lights and/or for the class of emergency call boxes and/or for the class of audio warning devices: status information making it possible to indicate whether the component is faulty or operational; and/or
for the class of barriers: an angular speed of opening and closing of the barrier, and/or an angle of inclination of the barrier with respect to a horizon when the barrier is in a fully open or fully closed position, and/or an angle of the barrier with respect to a road layout as drawn on a horizontal plane, and/or a height of the barrier with respect to a ground, and/or a time taken to lower and/or open the barriers and/or a physical appearance; and/or
for the class of audio warning devices: an indication as to an audio frequency and/or loudness and/or variations in frequency or loudness and/or active or inactive status of the warning device; and/or
for the class of traffic lights: an indication as to the frequency at which they flash and/or an indication as to whether they flash synchronously or in alternation with other traffic lights of the system and/or a physical appearance; and/or
for the panel class: an indication relating to a physical appearance and/or a material used.

6. The embedded system as claimed in claim 1, further configured to extract from said at least one received message one or more pieces of geometric information relating to roadways and railways intersecting in the level-crossing zone and/or to sections of overhead lines overlying a level crossing.

7. The embedded system as claimed in claim 1, wherein said processing module is configured to assist said at least one detecting module with detecting structural characteristics corresponding to one or more pieces of information extracted from said at least one received message.

8. The embedded system as claimed in claim 7, wherein the processing module is further configured to determine an entry boundary and/or an exit boundary and/or a presence of a level crossing and/or an open or closed status of the level crossing on a basis of at least detected structural characteristics corresponding to one or more pieces of information extracted from said at least one received message and relating to one or more structural components of said signaling and/or protecting system.

9. The embedded system as claimed in claim 1, wherein said processing module is configured to determine, based on said one or more pieces of information extracted from said at least one received message, whether said at least one external sensor and/or said at least one detecting module and/or the processing module are capable of handling crossing a level crossing.

10. The embedded system as claimed in claim 1, wherein said processing module is configured to determine, based on said one or more pieces of information extracted from said at least one received message, whether said motorized road vehicle is permitted, at least in terms of dimensions and/or weight, to cross a level crossing.

11. A fixed piece of infrastructure located in a level-crossing zone crossing a road, said fixed piece of infrastructure comprising:
a transmitting module configured to transmit messages via wireless communication,
wherein the transmitting module comprises, in at least one message to be transmitted, one or more pieces of information relating to a signaling and/or protecting system installed in said level-crossing zone, and/or relating to one or more structural components of said signaling and/or protecting system.

12. The fixed piece of infrastructure as claimed in claim 11, wherein said one or more pieces of information included in said at least one message to be transmitted comprises an indication defining a category of a level crossing in which the signaling and/or protecting system is installed.

13. The fixed piece of infrastructure as claimed in claim 11,
wherein said one or more pieces of information included in said at least one message to be transmitted comprise a set of indications relating to the structural components of said signaling and/or protecting system,
wherein said components belonging to one or more of the following classes: traffic lights, barriers, road line markings, traffic signs, traffic bollards, level-crossing panels, audio warning devices, emergency call boxes, height restriction barriers.

14. The fixed piece of infrastructure as claimed in claim 13, wherein said set of indications comprises, for each class, a number of components and/or, for each component, geographical coordinates, and/or a size or shape, and/or a type, and/or an index of visibility from the road.

15. The fixed piece of infrastructure as claimed in claim 13, wherein said set of indications further comprises:
for the class of barriers and/or for the class of traffic lights and/or for the class of emergency call boxes and/or for the class of audio warning devices: status information making it possible to indicate whether the component is faulty or operational; and/or
for the class of barriers: an angular speed of opening and closing of the barrier, and/or an angle of inclination of the barrier with respect to a horizon when the barrier is in a fully open or fully closed position, and/or an angle of the barrier with respect to a road layout as drawn on a horizontal plane, and/or a height of the barrier with respect to a ground, and/or a time taken to lower and/or open the barriers and/or a physical appearance; and/or
for the class of audio warning devices: an indication as to an audio frequency and/or loudness and/or variations in frequency or loudness and/or active or inactive status of the warning device; and/or
for the class of traffic lights: an indication as to the frequency at which they flash and/or an indication as to whether they flash synchronously or in alternation with other traffic lights of the system and/or a physical appearance; and/or
for the panel class: an indication relating to a physical appearance and/or a material used.

16. The fixed piece of infrastructure as claimed in claim 11, wherein said transmitting module is further configured to include, in said at least one message to be transmitted, one or more pieces of geometric information relating to roadways and railways intersecting in the level-crossing zone and/or to sections of overhead lines overlying a level crossing.
